(19) United States
(12) Patent Application Publication
(10) Pub. No.: US 2005/0275352 A1
(43) Pub. Date: Dec. 15, 2005

(54) Redundant storage capacitor and method for repairing OLED pixels and driving circuits

(75) Inventor: Wein-Town Sun, Hsinchu (TW)

Correspondence Address: Daniel R. McClure;Thomas, Kayden, Hortemeyer & Risley, L.L.P., 100 Galleria Parkway,, Suite 1750, Atlanta, GA, 30339-5948, US

(73) Assignee: AU Optronics Corporation.

(21) Appl. No.: 10/865,940

(22) Filed: Jun. 14, 2004

(51) Int. Cl. G09G 3/10

(52) U.S. Cl. 315/169.3

(57) ABSTRACT

A pixel of an electroluminescence device includes an organic light emitting diode (OLED), a driving transistor for driving the OLED, and first and second transistors connected in parallel with each other and to a gate of the driving transistor. Each of the first and second capacitors stores a gate-to-source voltage across the gate and source of the driving transistor. In the event one of the first and second capacitors fails, the failed capacitor can be disconnected from the pixel.

### DESCRIPTION OF THE INVENTION

1. Field of the Invention

This invention relates in general to an electroluminescence device and, more particularly, to a redundant storage capacitor of an electroluminescence device and a method for repairing pixels in an organic electroluminescence device.

2. Background of the Invention

An electroluminescence (“EL”) device is a device which makes use of the phenomenon of electroluminescence to emit light. An EL device generally includes thin film transistors (“TFT”) and light-emitting diodes (“LED”s). Each LED further includes a light-emitting layer. If the light-emitting layer contains organic light-emitting material, the device is referred to as an organic EL device. When a current passes between a cathode and an anode of the LED device, light is emitted through the light-emitting layer.

Generally, an active matrix organic light emitting diode (“OLED”) device or a polymer light emitting diode (“PLED”) device, either voltage-driven or current-driven, includes an array of pixels where each pixel comprises a set of sub-pixels. Examples of current-driven EL devices are found in U.S. Pat. Nos. 6,373,454 and 6,501,466. Each sub-pixel further includes a switching transistor, a driving transistor and a storage capacitor. The storage capacitor may include one end coupled to a gate of the driving transistor, and the other end coupled to a source of the driving transistor. If the ends of the storage capacitor are short-circuited, a voltage level V_{GS} across the gate and source of the driving transistor is zero. As a result, the driving transistor cannot be turned on, and a sub-pixel corresponding to the driving transistor exhibits a dark point when displayed. On the other hand, if the ends of the storage capacitor are open-circuited, the storage capacitor is electrically disconnected from the gate of the driving transistor. As a result, a voltage level at the gate of the driving transistor is susceptible to coupling effects and the V_{GS} value becomes unstable. In such a case, a sub-pixel corresponding to the driving transistor may flicker when displayed.

An OLED driver circuit, typically incorporated with a panel of a low temperature polycrystalline silicon (“LTPS”) device, includes a data driver comprising a current mirror circuit or a current copier circuit in conjunction with at least one storage capacitor for sampling a pixel current. If the at least one storage capacitor is short-circuited or open-circuited, a line defect may occur. It is thus desirable to provide an EL device that overcomes the aforementioned disadvantages in the art and, more particularly, an EL device in which defects can be eliminated when a capacitor for sampling a pixel current is open-circuited or short-circuited.

### SUMMARY OF THE INVENTION

To achieve these and other advantages, and in accordance with the purpose of the invention as embodied and broadly described, there is provided an electroluminescence device, comprising: a plurality of scan lines; a plurality of data lines orthogonal to the scan lines; and an array of pixels, each of the pixels formed near an intersection of one of the scan lines and one of the data lines, each pixel including a light emitting diode (LED) device, a driving transistor coupled to drive the LED device, and a plurality of capacitors, at least one of the capacitors being coupled to a gate of the driving transistor and another one of the capacitors being coupled either in parallel with the at least one capacitor or in a floating state, wherein each of the capacitors is provided for storing a voltage level for driving the driving transistor.

Also in accordance with the present invention, there is provided an electroluminescence device, comprising: an array of pixels; and a driver device for driving the array of pixels including a driving transistor and a plurality of capacitors, at least one of the capacitors being coupled to a gate of the driving transistor and another one of the capacitors being coupled either in parallel with the at least one capacitor or in a floating state, wherein each of the capacitors is provided for storing a voltage level across a gate and a source of the driving transistor.

Still in accordance with the present invention, there is provided a method for repairing an electroluminescence device, comprising: providing an array of pixels in the electroluminescence device; providing capacitors in each of the pixels; providing a transistor in each of the pixels; coupling at least one of the capacitors in each of the pixels to a gate of the driving transistor and coupling another one of the capacitors either in parallel with the at least one capacitor or in a floating state; and storing a voltage level in at least one of the capacitors for driving the driving transistor.

Further still in accordance with the present invention, there is provided a method for repairing an electroluminescence device, comprising: providing an array of pixels in the electroluminescence device; providing driving circuits for driving the array of pixels; providing capacitors in each of the driving circuits; providing a driving transistor in each of the pixels; and coupling at least one of the capacitors in each of the pixels to a gate of the driving transistor and coupling another one of the capacitors either in parallel with the at least one capacitor or in a floating state; and electrically connecting one of the driving circuits to a line of the pixels in the array.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a circuit diagram of a pixel of an electroluminescence device in accordance with an embodiment of the present invention;

FIG. 2 is a schematic layout of a pixel of an electroluminescence device in accordance with an embodiment of the present invention;

FIG. 3 is a circuit diagram of a pixel in accordance with another embodiment of the present invention;

FIG. 4 is a circuit diagram of a pixel in accordance with still another embodiment of the present invention;

FIG. 5 is a circuit diagram of a pixel in accordance with yet another embodiment of the present invention;

FIG. 6 is a circuit diagram of a pixel in accordance with yet still another embodiment of the present invention;

FIGS. 7A and 7B are diagrams illustrating a method for repairing a pixel in accordance with an embodiment of the present invention; and

FIG. 8 is a block diagram of a driver device in accordance with an embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

FIG. 1 is a circuit diagram of a pixel 10 of an electroluminescence device in accordance with an embodiment of the present invention. Pixel 10 includes switching transistors 12 and 14, a first capacitor 16, a second capacitor 18, a driving transistor 20 and an organic light emitting diode (“OLED”) device 22. Switching transistor 12 includes a gate (not numbered) coupled to a scan line, a source (not numbered) coupled to a data line, and a drain (not numbered). Switching transistor 14 includes a gate (not numbered) coupled to the scan line, a drain (not numbered) coupled to the drain of switching transistor 12, and a source (not numbered). Switching transistors 12 and 14 are n-type metal-oxide-semiconductor (“NMOS”) transistors. In one variation, pixel 10 can include a single switching transistor.

Driving transistor 20, which is a p-type metal-oxide-semiconductor (“PMOS”) transistor, includes a gate (not numbered), a source (not numbered) coupled to a voltage level Vdd, and a drain (not numbered). First capacitor 16 includes one end (not numbered) coupled to Vdd, and the other end (not numbered) coupled to the gate of driving transistor 20. Second capacitor 18 includes one end (not numbered) coupled to Vdd, and the other end (not numbered) coupled to the gate of driving transistor 20. OLED device 22 includes an anode (not numbered) coupled to the drain of driving transistor 20, and a cathode (not numbered) coupled to a voltage level Vss.

First capacitor 16 and second capacitor 18 are connected to each other in parallel. Each of the first capacitor 16 and the second capacitor 18 functions to store a gate-to-source voltage V_{GS} across the gate and source of driving transistor 20. If one of first capacitor 16 and second capacitor 18 fails, for example, becomes short-circuited or open-circuited, the other capacitor can still maintain proper functionality of pixel 10. In the event of such a failure, the failed capacitor would be disconnected from the circuit of pixel 10, for example by use of a laser. In one variation of the present embodiment, pixel 10 includes at least a third capacitor connected in parallel with the first and second capacitors and can include additional parallel connected capacitors.

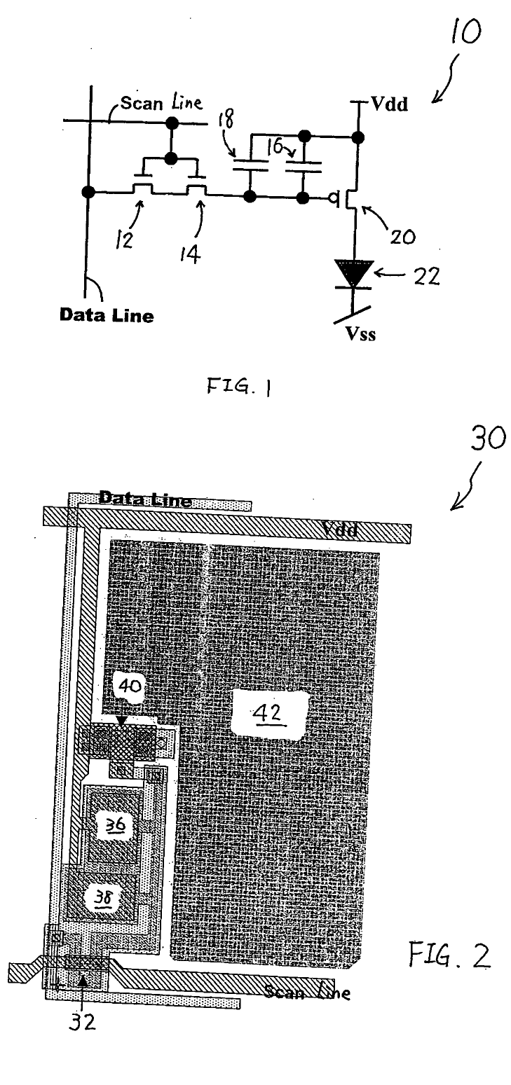

FIG. 2 is a schematic layout of a pixel 30 of an electroluminescence device in accordance with an embodiment of the present invention. Pixel 30 represents a schematic layout that embodies the circuit structure of pixel 10 shown in FIG. 1. Pixel 30 includes a switching transistor 32, a first capacitor 36, a second capacitor 38, a driving transistor 40 and an OLED device 42. First capacitor 36 and second capacitor 38 are connected to each other in parallel and correspond to capacitors 16 and 18 of pixel 10. Switching transistor 32 corresponds to the variation of pixel 10 in which only one of switching transistors 12 and 14 is provided. Driving transistor 40 and OLED device 42 correspond to driving transistor 20 and OLED device 22, respectively, of pixel 10. First capacitor 36 and second capacitor 38 occupy an area that is otherwise provided for a single capacitor in a conventional pixel.

FIG. 3 is a circuit diagram of a pixel 50 in accordance with another embodiment of the present invention. Pixel 50 includes switching transistors 52 and 54, a first capacitor 56, a second capacitor 58, a driving transistor 60 and an OLED device 62. Switching transistors 52 and 54 are NMOS transistors. Driving transistor 60, which is also an NMOS transistor, includes a gate (not numbered), a drain (not numbered) coupled to Vdd, and a source (not numbered). First capacitor 56 and second capacitor 58 are connected to each other in parallel. Each of the first capacitor 56 and the second capacitor 58 functions to store a gate-to-source voltage V_{GS} across the gate and source of driving transistor 60. First capacitor 56 includes one end (not numbered) coupled to a anode (not numbered) of OLED device 62, and the other end (not numbered) coupled to the gate of driving transistor 60. Second capacitor 58 includes one end (not numbered) coupled to the anode (not numbered) of OLED device 62, and the other end (not numbered) coupled to the gate of driving transistor 60. The anode of OLED device 62 is coupled to the source of driving transistor 60, and the cathode thereof (not numbered) is coupled to Vss.

As in the case of pixel 10, if one of first capacitor 56 and second capacitor 58 fails because of, for example, a short circuit or open circuit, the other one of the two capacitors can still maintain the functionality of pixel 50. In the event of such failure, the failed capacitor would be disconnected from the circuit of pixel 50. In one variation, pixel 50 can include one or more additional capacitors connected in parallel with first capacitor 56 and second capacitor 58.

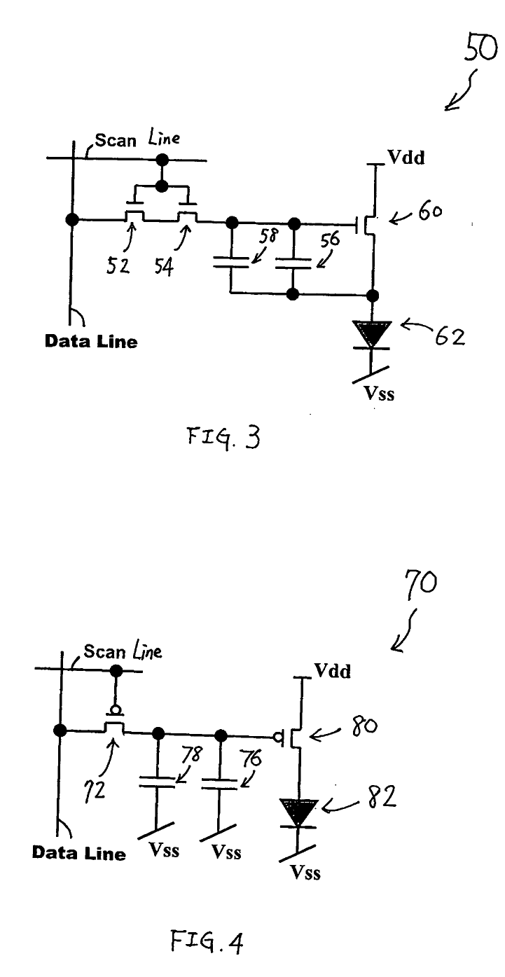

FIG. 4 is a circuit diagram of a pixel 70 in accordance with still another embodiment of the present invention. Pixel 70 includes a switching transistor 72, a first capacitor 76, a second capacitor 78, a driving transistor 80 and an OLED device 82. Switching transistor 72 and driving transistor 80 are PMOS transistors. First capacitor 76 and second capacitor 78 are connected to each other in parallel. First capacitor 76 includes one end (not numbered) coupled to Vss, and the other end (not numbered) coupled to a gate (not numbered) of driving transistor 80. Second capacitor 78 includes one end (not numbered) coupled to Vss, and the other end (not numbered) coupled to the gate of driving transistor 80. Driving transistor 80 includes a source connected to Vdd and a drain connected to the anode of OLED device 82. The cathode of device 82 is coupled to VSS.

As in the case of pixel 10, if one of first capacitor 76 and second capacitor 78 fails because of, for example, a short circuit or open circuit, the other one of the two capacitors can still maintain the functionality of pixel 70. In the event of such failure, the failed capacitor would be disconnected from the circuit of pixel 70. In one variation, pixel 70 can include one or more additional capacitors connected in parallel with first capacitor 76 and second capacitor 78.

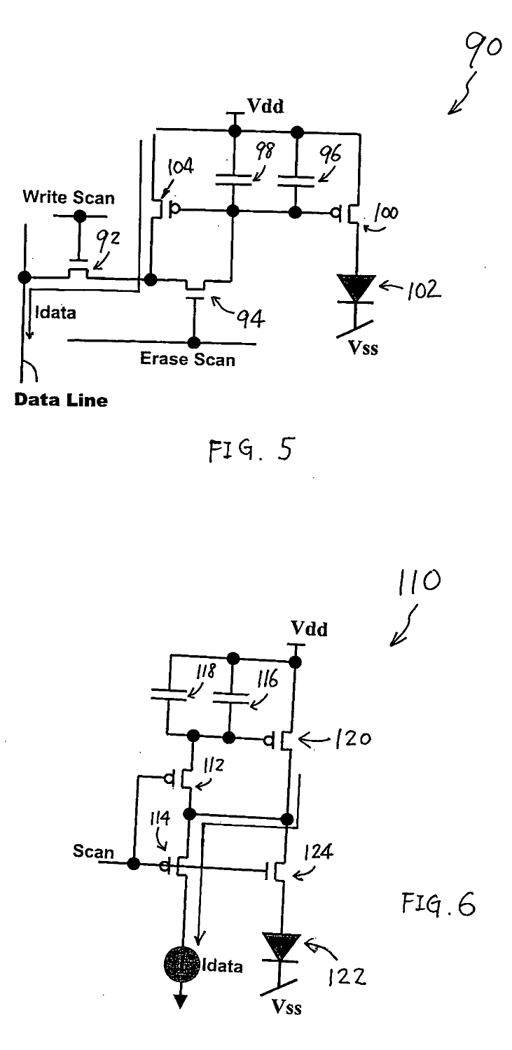

FIG. 5 is a circuit diagram of a pixel 90 in accordance with yet another embodiment of the present invention. Pixel 90 includes NMOS switching transistors 92 and 94, a first capacitor 96, a second capacitor 98, a PMOS driving transistor 100, an OLED device 102 and a PMOS transistor 104. Driving transistor 100 and transistor 104 together form a current mirror circuit, which provides a copy of current I_{data} flowing through transistor 104 for flowing through driving transistor 100.

Switching transistor 92 includes a gate (not numbered) coupled to a write scan line, a source (not numbered) coupled to a data line, and a drain (not numbered). Switching transistor 94 includes a gate (not numbered) coupled to an erase scan line, a drain (not numbered) coupled to the drain of switching transistor 92, and a source (not numbered). First capacitor 96 and second capacitor 98 are connected to each other in parallel. Each of the first capacitor 96 and the second capacitor 98 functions to store a gate-to-source voltage V_{GS} across a gate (not numbered) and a source (not numbered) of driving transistor 100.

As in the case of pixel 10, if one of first capacitor 96 and second capacitor 98 fails because of, for example, a short circuit or open circuit, the other one of the two capacitors can still maintain the functionality of pixel 90. In the event of such failure, the failed capacitor would be disconnected from the circuit of pixel 90. In one variation, pixel 90 can include one or more additional capacitors connected in parallel with first capacitor 96 and second capacitor 98.

FIG. 6 is a circuit diagram of a pixel 110 in accordance with yet a further embodiment of the present invention. Pixel 110 includes switching transistors 112, 114 and 124, a first capacitor 116, a second capacitor 118, a PMOS driving transistor 120, and an OLED device 122. Switching transistors 114 and 124 form a current copier circuit, which provides a copy of current I_{data} flowing through driving transistor 120 for flowing through transistor 124. First capacitor 116 and second capacitor 118 are connected to each other in parallel. Each of the first capacitor 116 and the second capacitor 118 functions to store a gate-to-source voltage V_{GS} across a gate (not numbered) and a source (not numbered) of driving transistor 120.

As in the case of pixel 10, if one of first capacitor 116 and second capacitor 118 fails because of, for example, a short circuit or open circuit, the other one of the two capacitors can still maintain the functionality of pixel 110. In the event of such failure, the failed capacitor would be disconnected from the circuit of pixel 110. In one variation, pixel 110 can include one or more additional capacitors connected in parallel with first capacitor 116 and second capacitor 118.

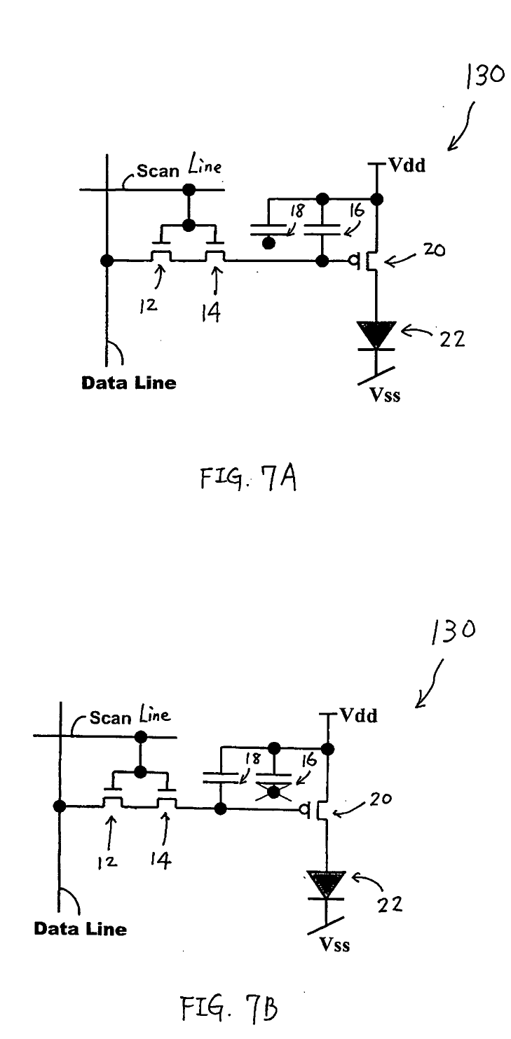

FIGS. 7A and 7B are diagrams illustrating a method for repairing a pixel 130 in accordance with an embodiment of the present invention. Referring to FIG. 7A, pixel 130 has a similar structure to pixel 10 shown in FIG. 1 except that one end of second capacitor 18 is floating. Referring to FIG. 7B, if first capacitor 16 fails due to, for example, short-circuiting or open-circuiting, connection of first capacitor 16 to driving transistor 20 is removed. The floating end of second capacitor 18 is then connected to driving transistor 20. In an aspect according to the present invention, a laser repair process is implemented to repair pixel 130.

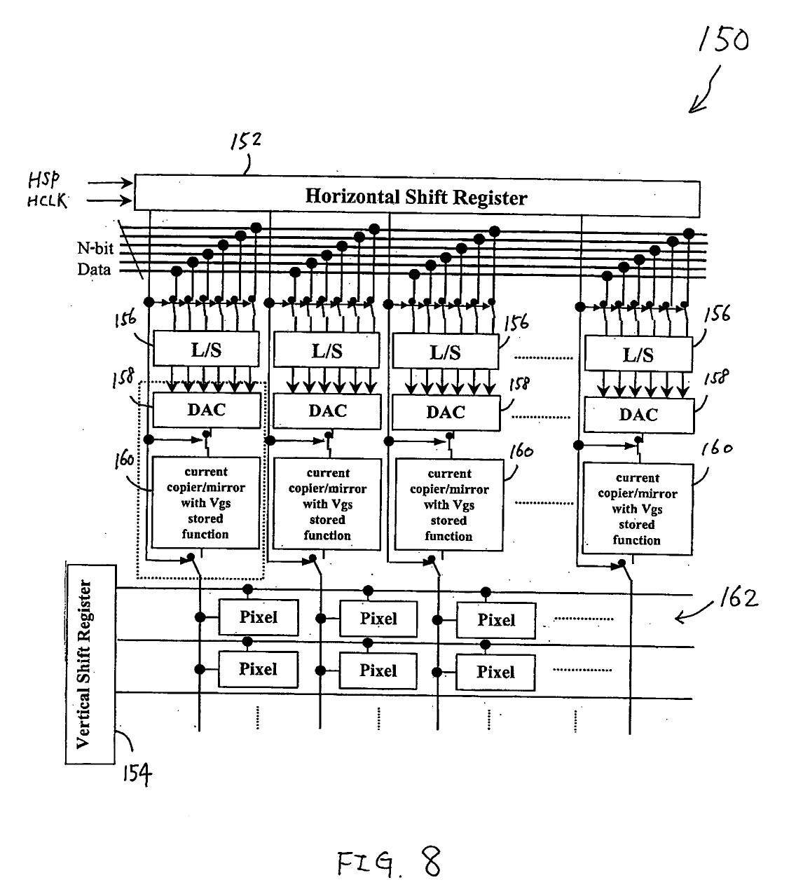

FIG. 8 is a block diagram of a driver device 150 in accordance with an embodiment of the present invention. Driver device 150 includes a horizontal shift register 152, a vertical shift register 154, level shifters (L/S) 156, digital-to-analog converters (DAC) 158, driving circuits 160, and an array of pixels 162. Each driving circuit 160 is electrically connected to a line or a column of pixels. If one of driving circuits 160 fails, a corresponding line of pixels cannot work properly, resulting in a line defect.

Each driving circuit 160 includes a current copier or current mirror in conjunction with capacitors. The capacitors are connected to one another in parallel. In one aspect, each of the capacitors functions to store a gate-to-source voltage level V_{GS} across a gate and a source of a driving transistor. If one of the capacitors fails, at least another one of the capacitors can maintain driver device 150 to function properly. In the event of such failure, the failed capacitor would be disconnected from the circuit. In another aspect, one of the capacitors is connected to the driving transistor, and the others are floating. If the one capacitor fails, a repair process is implemented to remove the failed capacitor and electrically connect at least another one of the capacitors to the driving transistor.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An electroluminescence device, comprising:
a plurality of scan lines;
a plurality of data lines orthogonal to the scan lines; and
an array of pixels, each of the pixels formed near an intersection of one of the scan lines and one of the data lines, each pixel including a light emitting diode (LED) device, a driving transistor coupled to drive the LED device, and a plurality of capacitors, at least one of the capacitors being coupled to a gate of the driving transistor and another one of the capacitors being coupled either in parallel with the at least one capacitor or in a floating state,
wherein each of the capacitors is provided for storing a voltage level for driving the driving transistor.

2. The device of claim 1 wherein one terminal of the capacitor in the floating state is coupled in common with one terminal of the at least one capacitor and another terminal of the floating state capacitor is unconnected.

3. The device of claim 1 wherein the LED device comprises an organic light emitting diode device.

4. The device of claim 1 wherein the LED device comprises a polymer light emitting diode device.

5. The device of claim 1 further comprising a current copier circuit coupled to copy a current flowing through a one of the data lines associated with one or more of the pixels.

6. The device of claim 1 comprising a current mirror circuit coupled to copy a current flowing through a one of the data lines associated with one or more of the pixels.

7. The device of claim 1 wherein the voltage level stored in each of the capacitors is a voltage level across the gate and a source of the driving transistor.

8. The device of claim 1 wherein at least one of the capacitors is disconnectable in an event of failure thereof.

9. An electroluminescence device, comprising:
an array of pixels; and
a driver device for driving the array of pixels including a driving transistor and a plurality of capacitors, at least one of the capacitors being coupled to a gate of the driving transistor and another one of the capacitors being coupled either in parallel with the at least one capacitor or in a floating state,
wherein each of the capacitors is provided for storing a voltage level across a gate and a source of the driving transistor.

10. The device of claim 9 wherein one terminal of the capacitor in the floating state is coupled in common with one terminal of the at least one capacitor and another terminal of the floating state capacitor is unconnected.

11. The device of claim 9 further comprising one of an organic light emitting diode device and a polymer light emitting diode device for driving by the driver device.

12. The device of claim 9 comprising one of a current copier circuit and a current mirror circuit coupled to copy a data current for driving one or more of the array of pixels.

13. The device of claim 9 wherein the driver device is incorporated within a low temperature polycrystalline silicon device.

14. A method for repairing an electroluminescence device, comprising:
providing an array of pixels in the electroluminescence device;
providing capacitors in each of the pixels;
providing a transistor in each of the pixels;
coupling at least one of the capacitors in each of the pixels to a gate of the driving transistor and coupling another one of the capacitors either in parallel with the at least one capacitor or in a floating state; and
storing a voltage level in at least one of the capacitors for driving the driving transistor.

15. The method of claim 14 comprising electrically connecting the floating state capacitor to the transistor.

16. The method of claim 14 comprising electrically disconnecting one of the capacitors from the transistor.

17. The method of claim 14 wherein the storing comprises storing a voltage level across a gate and a source of the driving transistor.

18. A method for repairing an electroluminescence device, comprising:
providing an array of pixels in the electroluminescence device;
providing driving circuits for driving the array of pixels;
providing capacitors in each of the driving circuits;
providing a driving transistor in each of the pixels; and
coupling at least one of the capacitors in each of the pixels to a gate of the driving transistor and coupling another one of the capacitors either in parallel with the at least one capacitor or in a floating state; and
electrically connecting one of the driving circuits to a line of the pixels in the array.

19. The method of claim 18 comprising electrically connecting the floating state capacitor to the transistor.

20. The method of claim 18 comprising electrically disconnecting one of the capacitors from the transistor using a laser repair.

21. The method of claim 18 comprising storing a voltage level across a gate and a source of the transistor in at least one of the capacitors.
